(19) United States
(12) Patent Application Publication
(10) Pub. No.: US 2013/0157580 A1
(43) Pub. Date: Jun. 20, 2013

(54) Spectrum Sensing Method, Apparatus, and System

(71) Applicant: Huawei Technologies Co., Ltd., Shenzhen (CN)

(72) Inventors: Jing Qiu, Chengdu (CN); Qian Zhang, Shenzhen (CN)

(73) Assignee: HUAWEI TECHNOLOGIES CO., LTD., Shenzhen (CN)

(21) Appl. No.: 13/768,006

(22) Filed: Feb. 15, 2013

Related U.S. Application Data
(63) Continuation of application No. PCT/CN2011/073640, filed on May 4, 2011.

(30) Foreign Application Priority Data
Aug. 17, 2010 (CN) 201010255171.0

(51) Int. Cl. H04B 17/00

(52) U.S. Cl. CPC H04B 17/00
USPC 455/67.11

(57) ABSTRACT

A method for performing spectrum sensing by using correlation between channels, to reduce the sensing time and increase the throughput while satisfying requirements for sensing accuracy is provided. The method according to the embodiments of the present invention includes: obtaining correlation information between target channels; obtaining a spectrum sensing result of at least one of the target channels; and determining a sensing result of another target channel according to the spectrum sensing result of the at least one of the target channels and the correlation information between the target channels.

### CROSS-REFERENCE TO RELATED APPLICATIONS

This application is a continuation of International Application No. PCT/CN2011/073640, filed on May 4, 2011, which claims priority to Chinese Patent Application No. 201010255171.0, filed on Aug. 17, 2010, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

Embodiments of the present invention relate to radio communication technologies, and in particular, to a cognitive radio technology.

### BACKGROUND

With the rapid increase of demands for radio communication services, currently available spectrum resources are coming into shortage. Therefore, the cognitive radio (CR) emerges. A cognitive radio is a radio system, where secondary users (non-authorized users) use idle spectrum resources in terms of space, frequency, and time to implement communication under the prerequisite of causing no interference to primary users (authorized users). In a cognitive radio system, the idle spectrum sensing technology is one of the technologies vital to the implementation of the cognitive radio technology. Therefore, spectrum sensing is an important technology for the cognitive radio.

The spectrum sensing is directed to monitoring and detecting signal activities of primary users on a specific frequency band. When detecting that an idle spectrum is available, the cognitive radio system may use the spectrum. When detecting presence of a signal of a primary user, the cognitive radio system must quit and release the frequency band within a specified time period. For effective detection of signals of the primary users, it is required that spectrum sensing and data transmission of the secondary users should not be performed concurrently. To enhance sensing accuracy, a long sensing time is required, and the data transmission time of the secondary users should be reduced, to reduce the throughput; however, if the sensing time is reduced, data transmission of the secondary users collides with that of the primary users, still reducing the throughput. In view of the above issue, a commonly-used approach is to perform spectrum sensing for each target channel. Therefore, how to reduce the sensing time and increase the throughput while satisfying the requirements for sensing accuracy is an important issue in the cognitive radio field.

### SUMMARY

Embodiments of the present invention provide a method for performing spectrum sensing by using correlation between channels, to reduce the sensing time and increase the throughput while satisfying the requirements for sensing accuracy.

An embodiment of the present invention provides a spectrum sensing method, including: obtaining correlation information between target channels; obtaining a spectrum sensing result of at least one of the target channels; and determining a sensing result of another target channel according to the spectrum sensing result of the at least one of the target channels and the correlation information between the target channels.

Further, an embodiment of the present invention provides a spectrum sensing node, including: a measurement fusing module configured to obtain correlation information between target channels; a spectrum sensing module configured to obtain a spectrum sensing result of at least one of the target channels; and a measurement analyzing module configured to determine a sensing result of another target channel according to the spectrum sensing result of the at least one of the target channels and the correlation information between the target channels.

An embodiment of the present invention provides a spectrum sensing system, including: a measurement fusing node configured to obtain correlation between target channels; and a sensing node configured to obtain correlation information between the target channels from the measurement fusing node, perform channel sensing for at least one of the target channels, predict a state of another unsensed channel according to a sensing result and the correlation information between the channels, and determine a sensing result of another target channel.

In the embodiments of the present invention, spectrum sensing needs to be performed for only a part of the channels, thereby reducing the duration of a sensing cycle. The sensing result of another unsensed channel is obtained through prediction by using the correlation between the channels. In this way, the overhead of the spectrum sensing is reduced, and the throughput of the system is increased.

### BRIEF DESCRIPTION OF THE DRAWINGS

FIG. 1 is a flowchart of a method according to an embodiment of the present invention;

FIG. 2 is a configuration diagram of a sensing timeslot according to an embodiment of the present invention;

FIG. 3 is a diagram of a spectrum sensing system based on spectrum prediction according to an embodiment of the present invention; and

FIG. 4 is a structural block diagram of a node in a dynamic spectrum access system based on spectrum predication according to an embodiment of the present invention.

### DETAILED DESCRIPTION

In the prior art, a secondary user needs to sense each target spectrum to determine whether the target spectrum is in an idle state. An embodiment of the present invention provides a spectrum sensing system based on spectrum prediction. The sensing result of another spectrum is predicated according to the correlation between channels and a part of sensing results.

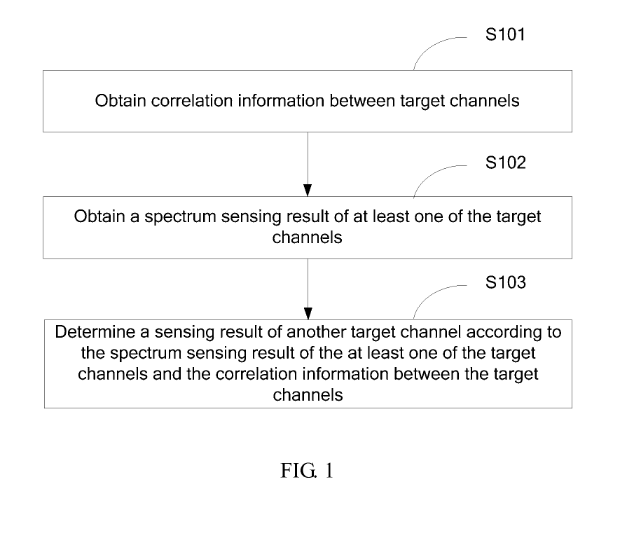

A dynamic access system based on spectrum predication may include a sensing measurement fusing node and a sensing node. In practice, the function of sensing measurement fusion may also be set on one sensing node. FIG. 1 is a method flowchart according to an embodiment of the present invention.

S101. Obtain correlation information between target channels.

The correlation information between the target channels is used to indicate similarity of spectrum usage between the channels. It is found during research of the embodiment of the present invention that the state of each channel in a next timeslot closely correlates with the history state of the channel. Therefore, on the basis that spectrum sensing is performed for a part of the channels, the state of another unsensed channel is predicated by using the obtained correlation information between the channels.

S102. Obtain a spectrum sensing result of at least one of the target channels.

Spectrum sensing is performed for a part of the target channels. Herein, a part of the channels may be at least one target channel for which spectrum sensing is to be performed.

If the system includes a sensing measurement fusing node, the correlation information between the target channels is calculated at the sensing measurement fusing node, and a sensing node performs sensing and sends a sensing result to the sensing measurement fusing node. Another implementation may be as follows: A specific sensing node, referred to as a central sensing node, obtains the correlation information between the target channels through calculation. The central sensing node senses a part of the target channels, and directly obtains the spectrum sensing results of the target channels.

S103. Determine a sensing result of another target channel according to the spectrum sensing result of the at least one of the target channels and the correlation information between the target channels.

The channels are correlated with each other. Therefore, after a part of the channels is sensed, the state of another unsensed channel may be predicated according to the sensing result and the correlation between the channels.

In one implementation, a correlation threshold may be set. If the correlation between two channels is greater than the threshold and if the sensing result of a first channel is sensed, it is predicated that a second channel has the same sensing result as the first channel. Therefore, the second channel does not need to undergo practical sensing and its sensing result is determined through predication by using the correlation between the two channels. Accordingly, the sensing results of all channels that do not undergo practical sensing may be determined through predication according to the sensing result of the channel whose similarity to the channels is greater than the threshold. Therefore, at least one channel or a plurality of channels may be sensed practically. Therefore, determining the sensing result of another target channel may be: determining that the sensing result of another target channel is the same as the sensing result of the at least one of the target channels if the similarity between the another channel and the at least one of the target channels is greater than a threshold.

For example, it is considered that two channels have the same sensing result if the correlation between the two channels is greater than 95%. At a specific time point, it is sensed that the state of a channel c is idle. Because the correlation between channels d and c is 96%, it is considered that the state of the channel d is also idle.

In the embodiment of the present invention, spectrum sensing needs to be performed for only a part of the channels, thereby reducing the duration of a sensing cycle. The sensing result of another unsensed channel is obtained through prediction by using the correlation between channels. In this way, the overhead of the spectrum sensing is reduced, and the throughput of the system is increased.

Further, another method of spectrum predication according to the present invention is described.

S201. Calculate the correlation between channels according to a spectrum measurement result.

The spectrum measurement result may be dynamically input by another spectrum measuring node or static history spectrum measurement information obtained in advance. The correlation information between target channels may include: times and durations of presence of primary users on two channels; or similarity of services on two channels; or similarity of signal to interference plus noise ratios on two channels. In conclusion, the correlation information between channels is used to indicate similarity of spectrum usage between the channels.

The following uses an example to describe a method for calculating the correlation between channels. In this embodiment, the probabilities of times and durations of presence are used to indicate the correlation information between the channels, that is, times and durations of presence are used as measurement information, which may be specifically understood as whether a primary user is present on a channel c.

The history measurement information of the channel c may be represented by a state sequence, for example, idle information of the channel, that is, the times and durations of presence of a primary user on the channel:

C̅S̅I̅(c)={CSI(c, t₁), CSI(c, t₂), . . . CSI(c, tₙ)}

where, t indicates a different timeslot and CSI indicates channel state information.

The correlation ρ(c₁, c₂) between channels c1 and c2 may be represented as follows:

$$CSI ( c , t ) = \{ \begin{matrix}0 , & if the channel c is idle in timeslot t \\ 1 , & if the channel c is busy in timeslot t\end{matrix} \\ ρ ( {c}_{1} , {c}_{2} ) = \frac{A - D}{A + D} \\ where , \\ A = ( \overline{CSI} ( {c}_{1} ) ⊕ \overline{CSI} ( {c}_{2} ) ) \\ where the number of 0 s indicates the number of same elements in the two sequences \\ D = ( \overline{CSI} ( {c}_{1} ) ⊕ \overline{CSI} ( {c}_{2} ) ) \\ where the number of 1 s indicates the number of different elements in the two sequences \\ \qquad ( 1 )$$

S202. A sensing node senses a part of the target channels to obtain the sensing results of the part of the target channels.

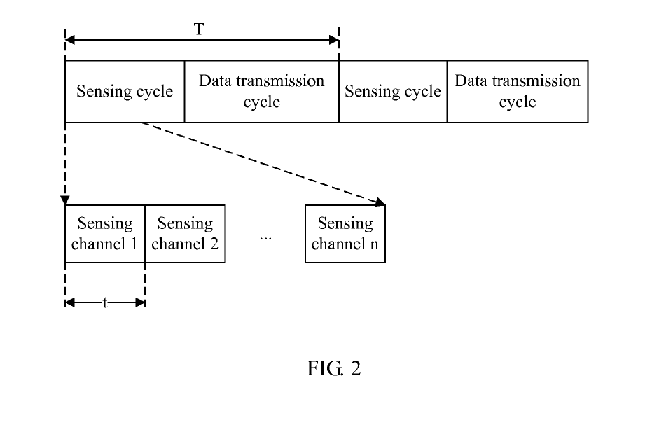

In this embodiment, a configuration manner for the sensing timeslot of the sensing node is shown in FIG. 2. A complete sensing period is formed by at least one sensing cycle and one data transmission cycle. Within a sensing cycle, a plurality of channels are sensed. The number of channels and the order of the channels sensed within a sensing cycle depend on a spectrum sensing policy. In this embodiment, the spectrum sensing policy may be determined according to the correlation between the channels. A sensing node or a measurement fusing node determines, according to the sensing policy, the channel to be sensed each time (that is, which channel is to be sensed). The sensing node senses the channel and obtains a sensing result.

In practice, the sensing policy may be determined first, the sensing order of selected target channels may be determined, and the selected target channels may be sensed according to the sensing order. When the sensing node performs channel sensing for a part of the target channels to obtain the sensing results of the part of the target channels, the determination of the sensing policy is based on the specific objective of the sensing node, and specifically, may be based on a specific optimization objective and a constraint condition. The optimization objective may include: maximization of average throughput for a single node or maximization of average system throughput; and the constraint condition may include: the probability of collision with a primary user, and the maximum access capability of a secondary user. For example, the sensing order of the target channels is determined according to the probability of collision between the secondary user and the primary user or the maximum access capability of the secondary user, where the sensing order enables maximum average throughput for a single node or maximum average system throughput. In practice, “maximum” may refer to approaching to the maximum.

The following uses an example to describe a spectrum sensing policy based on the maximum average throughput for a single node.

R(CAV) is used to indicate the average throughput of a sensing node.

$$R ( CAV ) = {\sum }_{n ∈ N} CAV ( n ) B ( T - it ) / T \qquad ( 2 )$$

N is a set of sensed channels, B is bandwidth of a single channel, T is a sensing period, and t is the time for sensing one channel. Equation (2) indicates average throughput of a single node when access is performed after i channels are sensed. The set N of the sensed channels indicates the channel to be actually sensed, not including the channel whose sensing result is determined through prediction. All target channels include the target channel practically sensed and the channel whose sensing result is obtained through predication.

After a next sensing action is performed to sense a channel a, the throughput gain obtained by the node is:

r(CAV, a)=E[R(CAV_{Next})−R(CAV_{Current})] (3)

The optimization objective of the node may be defined as maximizing the average throughput gain within each sensing period, that is:

$${V}_{{π}^{*}} ( C A V ) = {max}_{a ∈ π} E [ r ( C A V , a ) ] \qquad ( 4 )$$

The optimal spectrum sensing policy π* of a sensing node refers to the optimal channel sensing order satisfying equation (4).

After the sensing order is determined, the spectrum sensing may be implemented by a single node, or implemented by a plurality of nodes cooperatively. If single-node sensing is used, the sensitivity of the single-node sensing may be limited, and the single-node sensing can only reflect availability of spectrums neighboring to the node, but cannot reflect availability of spectrums within an entire communication range. If multi-node cooperative spectrum sensing is used, problems in the two aspects may be solved. Cooperative spectrum sensing uses a spatial diversity formed by sensing nodes in different physical locations in a CR network, to greatly improve global testing performance and obtain the availability of global spectrums. If multi-node sensing is used, a sensing measurement fusing node or a central sensing node may be used as the sensing node. The correlation information between the channels exists at the sensing measurement fusing node or the central sensing node.

S203. Predicate and determine the spectrum sensing result of another unsensed channel according to the sensing results of a part of the target channels and the correlation information between the target channels.

Channel availability (CA) is used to indicate the probability that a channel is idle at a specific time point. The channel availability may be determined according to times and durations of presence of a primary user on the channel, or services of a primary user, or a signal to interference plus noise ratio on the channel. The fewer the times of presence of the primary user and the shorter of the duration of presence, the higher the availability; the fewer the services of the primary user, the higher the availability; or the greater the signal to interference plus noise ratio, the higher the availability.

The availability of the channel c is represented by:

CA(c, t)=P{CSI(c, t)=0}

CAV (Channel Availability Vector) indicates the availability of a group of channels.

$$C A V ( c , t ) = C A ( c , t ) = P \{ C S I ( c , t ) = 0 \}$$

$$C A V ( c , t ) = \{ \begin{matrix}1 & if C S I ( c , t ) = 0 \\ 0 & if C S I ( c , t ) = 1\end{matrix}$$

After a channel s is sensed, the availability of another unsensed channel c may be obtained by using the following equation:

$$C A V ( c , t ) = \{ \begin{matrix}P \{ C S I ( c , t ) = C S I ( s , t ) \} & if C S I ( s , t ) = 0 \\ P \{ C S I ( c , t ) \neq C S I ( s , t ) ) & if C S I ( s , t ) = 1\end{matrix}$$

According to a statistical theory, when the history measurement information of a channel is sufficient,

$$C A V ( c , t ) = \{ \begin{matrix}\frac{A}{A + D} & if C S I ( s , t ) = 0 \\ \frac{D}{A + D} & if C S I ( s , t ) = 1\end{matrix}$$

According to equation (1),

$$C A V ( c , t ) = \{ \begin{matrix}( 1 + ρ ( s , c ) ) / 2 & if C S I ( s , t ) = 0 \\ ( 1 - ρ ( s , c ) ) / 2 & if C S I ( s , t ) = 1\end{matrix} \qquad ( 5 )$$

In equation (5), the channel correlation ρ(s, c) may be dynamically updated according to the sensing result. Therefore, the dimension of time change is implicitly embodied.

In the above embodiment, the correlation between channels may be calculated by the sensing measurement fusing node or the central sensing node used as a sensing node. Therefore, the entire method may be implemented in two modes: One is that the sensing measurement fusing node calculates and stores the correlation information between channels, receives or obtains the sensing results of a part of the target channels sensed by another sensing node, and then determines a spectrum sensing result of another channel according to the sensing results of a part of the target channels and the correlation between the target channels. Another mode is that the function of a sensing measurement fusing node is set on the central sensing node. The central sensing node calculates and stores the correlation information between channels, and senses the selected part of the target channels to obtain sensing results, where if multi-node sensing is used, the central sensing node receives or obtains the sensing results of the selected part of the target channels sensed by other sensing nodes, and then determines a spectrum sensing result of another channel according to the sensing results of a part of the target channels and the correlation between the target channels.

Further, when a channel predication method is used, it is possible that different sensing results are obtained for the same channel (c) through predication by using the sensing results of two different channels (s1 and s2). Therefore, the criterion for updating the sensing result of another target channel needs to be added. ETP is used to indicate the entropy of a channel state. The entropy of a channel is used to indicate uncertainty of the channel. The ETP of the channel c is calculated as follows:

ETP(c)=−CAV(c)log₂(CAV(c))−(1−CAV(c))log₂(1−CAV(c))

The smaller the entropy, the smaller the uncertainty of the channel, that is, the current state (0 or 1) of the channel is more easily determined. In this embodiment, the sensing result predicated for the channel is updated by using a low-uncertainty update criterion. The low-uncertainty update criterion may be described as follows: When equation (5) is used to predicate the channel c, if the entropy of the channel state after predication is smaller than the entropy of the channel state before predication, the current state of the channel c is updated according to the result predicated by using equation (5).

In the embodiments of the present invention, spectrum sensing needs to be performed for only a part of the channels, thereby reducing the duration of a sensing cycle. The sensing result of another unsensed channel is obtained through prediction by using the correlation between the channels. In this way, the overhead of the spectrum sensing is reduced, and the throughput of the system is increased. Meanwhile, the order and policy of the target channels to be sensed are determined by using the correlation between the channels, and the sensing result of another target channel is predicted according to the sensing result, thereby improving the accuracy of the system, and further reducing the sensing time and increasing the throughput while satisfying requirements for sensing accuracy.

From the aspect of the above method embodiment, another embodiment is described. Direct correlation between target spectrums is determined first and a binding relationship is established between the correlated spectrums. Information of the binding relationship may be stored on a sensing node, a measurement fusing node, or another node in the system. The sensing node may obtain the binding relationship during sensing of target channels, that is, obtain correlation information between the target channels. Before sensing the target channels one by one, the sensing node first queries the binding relationship to sense a part of the target channels involved in the binding relationship. If the binding relationship exists and a spectrum has been sensed, another target channel does not need to be sensed but are determined through predication according to the binding relationship.

An embodiment of the present invention further provides a system for implementing the above method, including a measurement fusing node and a sensing node. The measurement fusing node and the sensing node may be a node deployed in a gateway, base station, relay station, terminal, or in another equipment. The following uses spectrum sensing involving cooperation of a base station and a mobile terminal in a cellular network as an example to describe the application of the above method. In cooperative spectrum sensing in a cellular network, the base station uniformly manages terminals involved in the cooperative spectrum sensing in a cell, including selection of a sensing node, assignment of sensing tasks, and decision on sensing and access policies. The base station sends a decision result of a spectrum sensing policy to all terminals involved in the cooperative spectrum sensing. The terminals perform local sensing, and report sensing results to the base station. The base station fuses the sensing results of all cooperative sensing nodes, and makes decisions on sensing and access based on the correlation information between the channels.

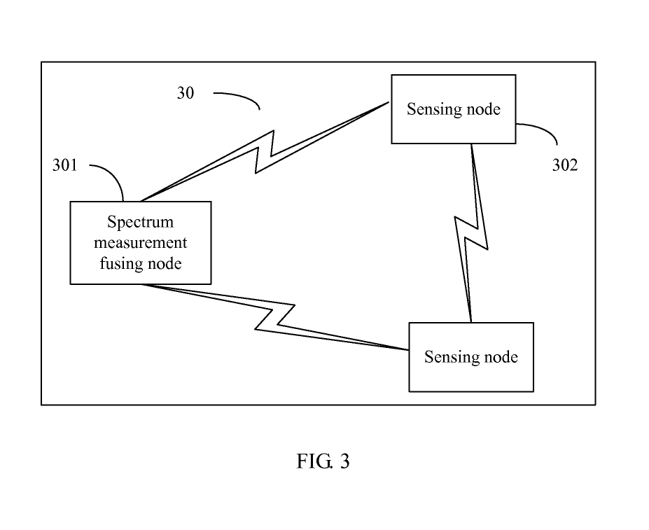

FIG. 3 shows a spectrum sensing system 30 based on spectrum prediction. The system 30 includes a spectrum measurement fusing node 301 and at least one sensing node 302. In a specific system, a plurality of sensing nodes 302 may exist. The measurement fusing node 301 may obtain correlation between target channels. The correlation between the target channels is calculated according to an existing spectrum measurement result. The existing spectrum measurement result may be dynamically input by another spectrum measuring node or static history spectrum measurement information obtained in advance. The correlation information between the target channels is used to indicate similarity of spectrum usage between the channels. The correlation information may be probabilities of times and durations of presence of primary users on two channels, or similarity of services on two channels, or similarity of signal to interference plus noise ratios on two channels. The sensing node 302 obtains the correlation between the target channels from the measurement fusing node 301, performs channel sensing for at least one of the target channels, predicts a state of another unsensed channel according to a sensing result and the correlation information between the channels, and determines a sensing result of another target channel. When similarity of the another channel and the at least one of the target channels is greater than a threshold, the sensing node 302 determines that the sensing result of the another target channel is the same as the sensing result of the at least one of the target channels.

Further, the measurement fusing node 301 determines a sensing policy according to the correlation between the target channels, selects a target channel that needs to be sensed by the sensing node 302, and determines a sensing order. Alternatively, the sensing node 302 may obtain the correlation between the target channels, determine the sensing policy of the sensing node, select a target channel that needs to be sensed by the sensing node, and then determine a sensing order. Either the measurement fusing node 301 or the sensing node 302 determines, according to the probability of collision between a secondary user and a primary user, or the maximum access capability of a secondary user, the sensing order of the target channels, where the sensing order enables the maximum average throughput for a single node or maximum average system throughput.

Further, the sensing node 302 may also calculate the entropy of a target channel whose sensing result is obtained through prediction, use the entropy to indicate uncertainty of the channel, and correct the sensing result of the another target channel according to a low-uncertainty update criterion.

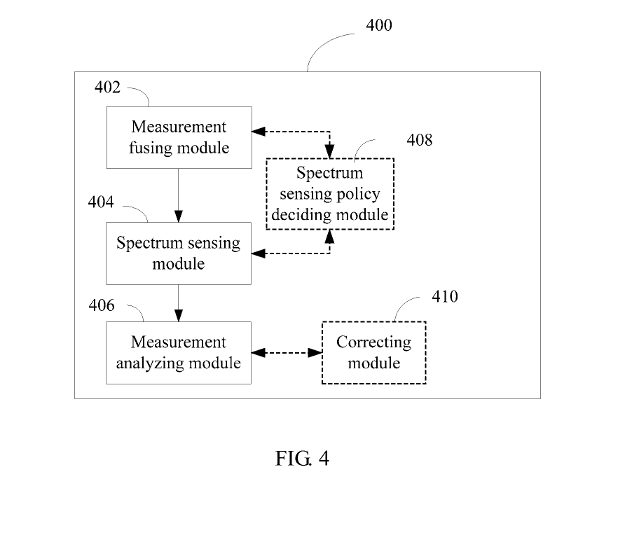

An embodiment of the present invention further provides a node in a spectrum sensing system based on spectrum prediction. The node implements the above methods. The node herein may be a node deployed in a gateway, base station, relay station, terminal, or the like. FIG. 4 is a structural block diagram of a node in a dynamic spectrum access system based on spectrum predication according to this embodiment. A node 400 includes: a measurement fusing module 402, a spectrum sensing module 404, and a measurement analyzing module 406. The measurement fusing module 402 is configured to obtain correlation information between target channels. The correlation information between the target channels is used to indicate the similarity of spectrum usage between the channels. The correlation information may be probabilities of times and durations of presence of primary users on two channels, or similarity of services on two channels, or similarity of signal to interference plus noise ratios on two channels. The spectrum sensing module 404 is configured to obtain a spectrum sensing result of at least one of the target channels. The spectrum sensing module 404 may obtain the spectrum sensing result in two modes: One is that the node senses a target channel to obtain a sensing result. Another is that the node receives a sensing result after another node senses a target channel; and in this mode, in a spectrum sensing system based on spectrum prediction, the current node may be considered as a measurement fusing node or a central sensing node, and the another sensing node notifies the sensing result to the current node after sensing the target channel. The measurement analyzing module 406 is configured to determine a sensing result of the another target channel according to the obtained spectrum sensing result of the at least one of the target channels and the correlation information between the target channels. When similarity of the another channel and the at least one of the target channels is greater than a threshold, the measurement analyzing module 406 determines that the sensing result of the another target channel is the same as the sensing result of the at least one of the target channels.

In the embodiment of the present invention, spectrum sensing needs to be performed for only a part of the channels, thereby reducing the duration of a sensing cycle. The sensing result of another unsensed channel is obtained through prediction by using the correlation between channels. In this way, the overhead of the spectrum sensing is reduced, and the throughput of the system is increased.

Further, the node 400 includes a spectrum sensing policy deciding module 408 configured to determine a sensing policy, select, according to the correlation information between the target channels, at least one target channel from the target channels for spectrum sensing, determine a sensing order for the selected target channels, and sense the selected target channels according to the sensing order. In implementation, the spectrum sensing module 404 performs spectrum sensing according to the sensing policy determined by the spectrum sensing policy deciding module 408. Alternatively, the current node may send the sensing policy determined by the spectrum sensing policy deciding module 408 to another sensing node, and the another sensing node senses a target channel according to the sensing policy, and sends a sensing result to the current node. Therefore, the spectrum sensing module 404 may directly perform spectrum sensing for at least one of the target channels; or a spectrum sensing result of the at least one of the target channels sent by another sensing node is received and the spectrum sensing result is sent to the spectrum sensing module 404, where the another sensing node performs spectrum sensing for the target channel. The spectrum sensing policy deciding module 408 determines, according to the probability of collision between a secondary user and a primary user or the maximum access capability of a secondary user, the sensing order of the target channels, where the sensing order enables maximum average throughput for a single node or maximum average system throughput.

Still further, the node 400 includes a correcting module 410, where the correcting module 410 calculates the entropy of a target channel whose sensing result is obtained through prediction, uses the entropy to indicate the uncertainty of the channel, and corrects a sensing result of another target channel according to a low-uncertainty update criterion.

In the embodiment of the present invention, spectrum sensing needs to be performed for only a part of the channels, thereby reducing the duration of a sensing cycle. The sensing result of another unsensed channel is obtained through prediction by using the correlation between the channels. In this way, the overhead of the spectrum sensing is reduced, and the throughput of the system is increased. Meanwhile, the order and policy of the target channels to be sensed are determined by using the correlation between the channels, and the sensing result of another target channel is predicted according to the sensing result, thereby improving the accuracy of the system, and further reducing the sensing time and increasing the throughput while satisfying requirements for sensing accuracy.

Persons of ordinary skill in the art should understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a read-only memory (ROM), a random-access memory (RAM), a magnetic disk, or an optical disk.

What is claimed is:

1. A spectrum sensing method comprising:
obtaining correlation information between target channels;
obtaining a spectrum sensing result of at least one of the target channels; and
determining a sensing result of another target channel according to the spectrum sensing result of the at least one of the target channels and the correlation information between the target channels.

2. The method according to claim 1, wherein the correlation information between the target channels indicates similarity of spectrum usage between the target channels.

3. The method according to claim 1, wherein obtaining the spectrum sensing result of the at least one of the target channels comprises:
directly performing spectrum sensing for the at least one of the target channels; or
receiving the spectrum sensing result of the at least one of the target channels sent by a sensing node, wherein the sensing node performs spectrum sensing for the at least one of the target channels.

4. The method according to claim 3, wherein performing the spectrum sensing for the at least one of the target channels comprises:
selecting, according to the correlation information between the target channels, at least one target channel from the target channels for spectrum sensing;
determining a sensing order of the selected target channels; and
sensing the selected target channels according to the sensing order.

5. The method according to claim 2, wherein the correlation information between the target channels comprises at least one of:
probabilities of times and durations of presence of primary users on two channels;
similarity of services on the two channels; or
similarity of signal to interference plus noise ratios on the two channels.

6. The method according to claim 1, wherein obtaining the correlation information between the target channels comprises:
obtaining the correlation information between the target channels through calculation according to a spectrum measurement result sent by another spectrum measuring node; or
obtaining the correlation information between the target channels through calculation according to static history spectrum measurement statistic information.

7. The method according to claim 1, further comprising:
calculating an entropy of the another target channel and using the entropy to indicate uncertainty of the channel; and
correcting the sensing result of the another target channel according to a low-uncertainty update criterion.

8. The method according to claim 3, wherein determining the sensing order of the selected target channels comprises: determining, according to a probability of collision between a secondary user and a primary user or a maximum access capability of a secondary user, the sensing order of the target channels, wherein the sensing order enables maximum average throughput for a single node or maximum average system throughput.

9. The method according to claim 1, wherein determining the sensing result of the another target channel according to the spectrum sensing result of the at least one of the target channels and the correlation information between the target channels comprises determining that the sensing result of the another target channel is the same as the sensing result of the at least one of the target channels when similarity of the another target channel and the at least one of the target channels is greater than a threshold.

10. A node in a spectrum sensing system comprising:
a measurement fusing module configured to obtain correlation information between target channels;
a spectrum sensing module configured to obtain a spectrum sensing result of at least one of the target channels; and
a measurement analyzing module configured to determine a sensing result of another target channel according to the spectrum sensing result of the at least one of the target channels and the correlation information between the target channels.

11. The node according to claim 10, wherein the correlation information between the target channels that is obtained by the measurement fusing module indicates similarity of spectrum usage between the target channels.

12. The node according to claim 10, wherein obtaining the spectrum sensing result of the at least one of the target channels by the spectrum sensing module comprises:
directly performing, by the spectrum sensing module, spectrum sensing for the at least one of the target channels; or
receiving the spectrum sensing result of the at least one of the target channels sent by another sensing node, wherein the another sensing node perform spectrum sensing for the target channel.

13. The node according to claim 12, further comprising a spectrum sensing policy deciding module configured to select, according to the correlation information between the target channels, at least one target channel from the target channels for spectrum sensing, and determine a sensing order of the selected target channels, wherein the spectrum sensing module or the another node senses the selected target channels according to the sensing order.

14. The node according to claim 13, wherein the spectrum sensing policy deciding module determines, according to a probability of collision between a secondary user and a primary user or a maximum access capability of a secondary user, the sensing order of the target channels, wherein the sensing order enables maximum average throughput for a single node or maximum average system throughput.

15. The node according to claim 10, further comprising a correcting module configured to calculate an entropy of the another target channel, use the entropy to indicate uncertainty of the channel, and correct the sensing result of the another target channel according to a low-uncertainty update criterion.

16. The node according to claim 10, wherein the measurement analyzing module determines that the sensing result of the another target channel is the same as the sensing result of the at least one of the target channels when similarity of the another target channel and the at least one of the target channels is greater than a threshold.

17. A spectrum sensing system comprising:
a measurement fusing node configured to obtain correlation between target channels; and
a sensing node configured to obtain correlation information between the target channels from the measurement fusing node, perform channel sensing for at least one of the target channels, predict a state of another target channel according to a sensing result and the correlation information between the target channels, and determine a sensing result of the another target channel.

18. The system according to claim 17, wherein the measurement fusing node selects, according to the correlation information between the target channels, a target channel that is to be sensed by the sensing node, and determines a sensing order.

19. The system according to claim 17, wherein after obtaining the correlation information between the target channels from the measurement fusing node, the sensing node selects, according to the correlation information between the target channels, a target channel that is to be sensed, and determines a sensing order.

20. The system according to claim 18, wherein the measurement fusing node or the sensing node determines, according to a probability of collision between a secondary user and a primary user or a maximum access capability of a secondary user, the sensing order of the target channels, wherein the sensing order enables maximum average throughput for a single node or maximum average system throughput.

21. The system according to claim 17, wherein the sensing node calculates an entropy of the another target channel, and corrects the sensing result of the another target channel according to a low-uncertainty update criterion, and wherein the entropy indicate uncertainty of the channel.

22. The system according to claim 17, wherein the node determines that the sensing result of the another target channel is the same as the sensing result of the at least one of the target channels when similarity of the another channel and the at least one of the target channels is greater than a threshold.
